(19) United States
(12) Patent Application Publication
(10) Pub. No.: US 2013/0154809 A1
(43) Pub. Date: Jun. 20, 2013

(54) METHOD AND APPARATUS FOR LOCATING AN ITEM WITHIN A RADIO FREQUENCY IDENTIFICATION MONITORED AREA

(71) Applicants: PANCHAPAKESAN V. SUBRAMANIAN, FREDERICK, MD (US); ROBERT C. ARNESON, BALTIMORE, MD (US)

(72) Inventors: PANCHAPAKESAN V. SUBRAMANIAN, FREDERICK, MD (US); ROBERT C. ARNESON, BALTIMORE, MD (US)

(73) Assignee: SYMBOL TECHNOLOGIES, INC., HOLTSVILLE, NY (US)

(21) Appl. No.: 13/329,933

(22) Filed: Dec. 19, 2011

(51) Int. Cl. H04Q 5/22

(52) U.S. Cl. 340/10.42; 340/10.6

(57) ABSTRACT

A method and apparatus for locating an item within an RFID monitored area. When attempting to locate an item using an RFID reader, an interrogation signal is transmitted for at least one RFID tag. A responsive signal from the interrogated RFID tag is processed using data from one or more orientation sensors configured within the RFID reader to determine a direction from the RFID reader toward the RFID tag. The direction toward the RFID tag is displayed and the process repeats while movement of the RFID reader is detected to assist the user in locating the RFID tag, and thus, the item.

### FIELD OF THE DISCLOSURE

The present disclosure relates generally to remotely identifying and locating objects, and more particularly relates to remotely identifying and locating objects using radio frequency identification (RFID) signaling.

### BACKGROUND

In modern supply management systems, there is often a need to determine the presence and location of a specific object, as for example, an item stored in a retail store or a warehouse. For example, a warehouse attendant may need to determine whether a particular item is present and where it is located. When there are many items that are similar in appearance, or an item has been moved or misplaced, this can be a daunting and very time consuming task.

RFID tags are often attached to an item to provide a unique identifier (e.g., an ID number) via a radio frequency (RF) signal. When the RFID tag is interrogated by an RFID reader, the RFID tag responds with at least its tag identifier. Typically, the tag identifier is associated with the item to which the tag is attached in some system controller or computer system. If the tag identifier of the desired item is among those RFID tag(s) interrogated by the RFID reader, then the user will know that the item is present, but may still not know its exact location, and thus, have to locate the item within the monitored area.

Accordingly, there is a need for a method and apparatus for locating an item within an RFID monitored area.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of an exemplary environment in which the disclosed system may practice the disclosed method in accordance with some embodiments.

FIG. 2 is an illustration of an RFID reader and item having an RFID tag in accordance with some embodiments.

FIG. 3 is a block diagram of the RFID reader of FIG. 2.

FIGS. 4-6 are illustrations of exemplary screen displays for the RFID reader of FIG. 2.

FIG. 7 is a flowchart of a method for locating items having an RFID tag in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Techniques are provided for locating an item within an RFID monitored area. When attempting to locate an item using an RFID reader, the RFID reader initiates the transmission of an interrogation signal for at least one RFID tag. A responsive signal from the interrogated RFID tag is processed using data from one or more orientation sensors configured within the RFID reader to determine a direction from the RFID reader toward the RFID tag. The direction toward the RFID tag is displayed and the process repeats while movement of the RFID reader is detected to assist the user in locating the RFID tag, and thus, the item.

Generally, the present disclosure describes a system and method for locating objects using RFID technology. As is known, an RFID reader has the ability to select one or more RFID tags by transmitting an identifier that specifies one or more of the tags from a plurality of tags. When an RFID reader selects an RFID tag, the RFID tag is put into a responsive mode and the tag transmits data back to the reader which is received at the RFID reader antenna.

Since an RFID reader can be used to select one or more RFID tags and retrieve data from the selected tags, an RFID reader can be used to identify and track large numbers of objects. In fact, RFID systems offer an advantage in object location due to the transmission range, lack of a line of sight requirement between a tag and its reader and high tag reading throughput.

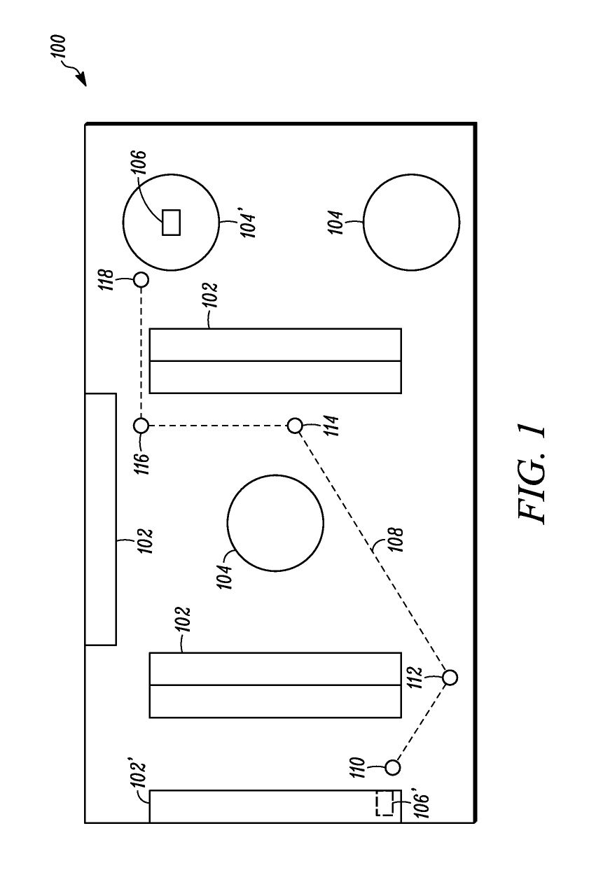

FIG. 1 is a block diagram of an exemplary environment 100 in which the disclosed system may practice the disclosed method in accordance with some embodiments. Although the environment 100 is illustrated as a retail store, it will be appreciated that the environment for the present disclosure may be a warehouse or other storage facility. As can be seen, the environment 100 includes several shelving units 102 and display tables 104 for storage and presentations of items offered for sale to customers. In this simplified example, one item 106 has been misplaced from an expected location 106′ on shelf 102′, and presently resides on display table 104′. Thus, a customer wishing to purchase item 106 may believe the item to be out of stock when in fact it has merely been misplaced or moved by another customer. According to exemplary embodiments of the present disclosure, an RFID reader may be used to guide a store employee along a path 108 through location waypoints 110-118 to locate the item 106.

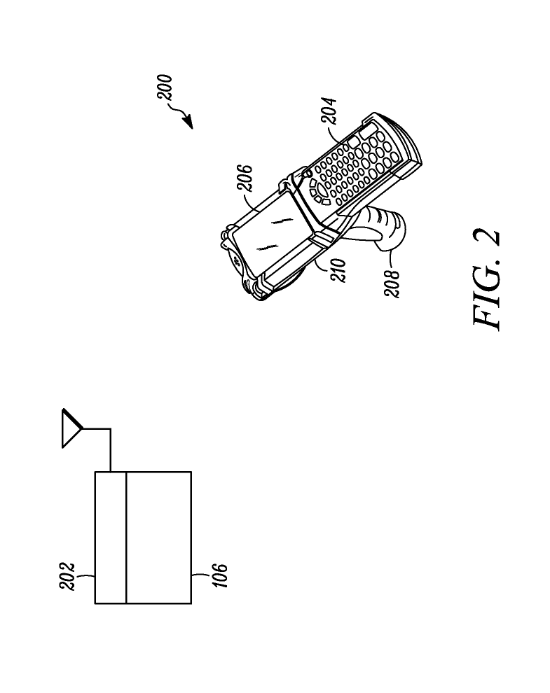

FIG. 2 is an illustration of an RFID reader 200 and the item 106 (see FIG. 1) having an RFID tag 202 in accordance with some embodiments. In the illustrated embodiment, a portable RFID reader 200 includes various input devices 204, a display screen 206, and a handle 208 on a housing 210. The housing 210 may be a single unit that contains all of the components of the RFID reader 200. Alternatively, the housing 210 may be various interconnected units containing all of the components of the RFID reader 200. The input devices 204 may include keys, a keypad, a mouse/pointing device, scroll bars, touch pads, and the like. The display screen 206 may include a liquid crystal display (LCD) or the like for presenting a graphical user interface and associated data to a user.

Operationally, a user may hold the RFID reader 200 via the handle 208 thereby orienting the RFID reader 200 in an outward direction from the user. The user typically operates the RFID reader 200 through a combination of inputs and outputs with the input devices 204 and the display screen 208. According to embodiments of the present disclosure, the RFID reader 200 is configured to interrogate remote RFID tags wirelessly through the use of the various antenna designs configured within the housing 210. The particular antenna employed in any particular implementation may be realized by any number of antenna types (e.g., loop, dipole, monopole, patch or helix). Also, the antenna may have a particular polarization (e.g., vertical, horizontal or circular) in some embodiments. Additionally, the RFID reader 200 may include one or more triggers (not shown) for selecting or activating various operational modes or features of the RFID reader 200.

The RFID tag 202 may take on a variety of configurations, shapes and sizes. For example, different tags for different applications typically have a shape and size appropriate for its application. RFID tags are commonly categorized as active, passive or semi-passive. Active RFID tags include an internal battery used to power the tag and transmit data and typically include the ability to read and write greater amounts of stored data than either passive or semi-passive tags. Passive RFID tags transmit by reflecting and absorbing energy from the RF transmissions from the reader, and use absorbed energy from the reader for data storage, retrieval and manipulation. Semi-passive tags include an internal battery that is used for data storage, retrieval and manipulation, and transmit data by reflecting and absorbing energy from the reader. Any of these RFID tag types are suitable for use as the RFID tag 202 in the disclosed exemplary embodiments.

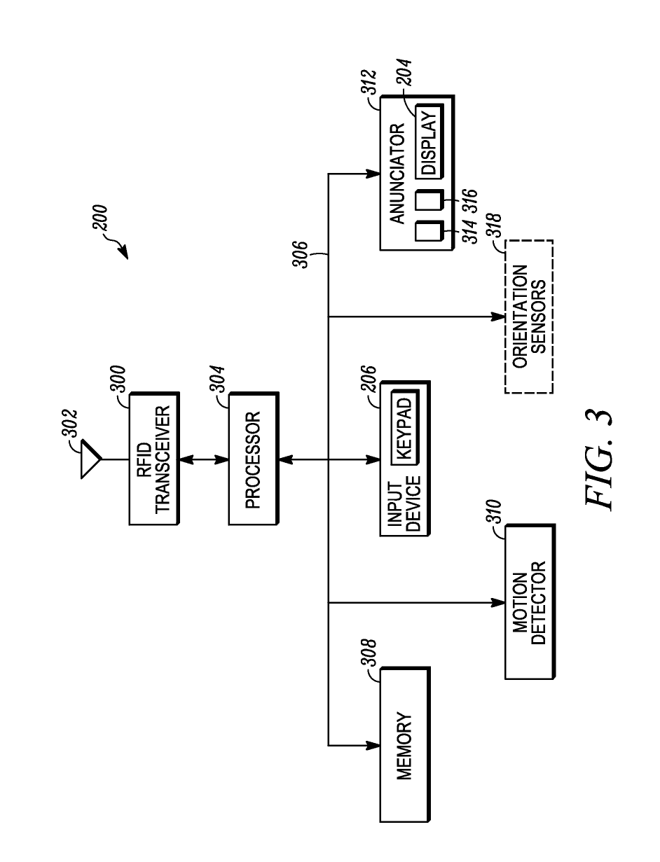

FIG. 3 is a block diagram of the RFID reader (200 in FIG. 2). The RFID reader 200 communicates with the RFID tag 202 via an RFID transceiver 300 and antenna 302. As is known, RFID systems can use a variety of techniques to transmit data to and from the tag. For transmission to the tag, the data can be transmitted using any of a variety of modulation techniques, including amplitude modulation (AM), phase modulation (PM), and frequency modulation (FM). Furthermore, the data transmitted to the tag can be encoded using any of a variety of techniques, including frequency shift keying (FSK), pulse position modulation (PPM), pulse duration modulation (PDM), and amplitude shift keying (ASK).

Responsive signals received from the RFID tag 202 are processed by processor 304, which in some embodiments may be realized as a digital signal processor (DSP). The processor 304 is coupled to a bus 306 (or other communication network) to be operably coupled to a memory 308, input device 204 (see FIG. 2), a motion detector 310 (e.g., accelerometer) and an annunciator 312. The annunciator 312 includes the display 206 (see FIG. 2) and may include various audible annunciators (e.g., speakers) 314 or visual annunciators 316 (e.g., light emitting diodes). Optionally, the RFID reader 200 may also include various orientation sensors 318 for detecting changes in the manner in which the user is holding the RFID reader 200 (e.g., pitch, roll and/or yaw).

Referring still to FIG. 3 and also to FIGS. 1 and 2, exemplary embodiments contemplate the RFID reader 200 being selectively placed into a search mode by a user activating one or more input devices 204 and/or a trigger. When searching for an item 106, the RFID reader 200 detects motion (via motion detector 310) and a direction of travel and begins to transmit and receive signals to communicate with a selected RFID tag 202. The direction of travel may be determined by the orientation sensors 318 or other direction indicator, such as an electronic compass within the motion detector 310. The RFID tag 202 that is associated with the item 106 that is the subject of the search may be identified by the input device 204, by being selected from memory 308 or any other convenient means.

The responsive signals received from the RFID tag 202 are analyzed by the processor 304 to determine various receive quality indicators and compare those received quality indicators to those of prior receptions to determine (or estimate) a direction from the RFID reader 200 to the RFID tag 202. The receive quality indicators include, but are not limited to, RFID tag read rate, RFID tag read count, bit error rate and received signal strength. Thus, for example, as a user approaches the RFID tag 202, the receive quality indicators should improve between successive communication between the RFID reader 200 and the RFID tag 202. Should a user move further away from the RFID tag 202 (either in error or out of necessity due to an obstacle), the receive quality indicators should decline, allowing the processor to indicate to the user a corrective course to locate the RFID tag 202, and thus, the item 106.

In some embodiments, the processor 304 directs a user toward an item 106 via the display 206. This may be accomplished via written directions (e.g., “continue ahead”, “bear left”, “turn right”) or a graphical display as will be discussed in more detail below. Alternately (or additionally), some embodiments may incorporate an audible annunciator 314 (e.g., a “beep” sound with increasing period as the user approaches the RFID tag 202), machine-generated spoken audio and/or a visual annunciator 316 (e.g., a light flashing with increasing frequency as the user approaches the RFID tag 202).

Referring now to FIGS. 1-4, an exemplary search example is provided to facilitate understanding of the present disclosure. When the user (or employee) determines that the item 106 is not in the expected location 106′ on the shelf 102′, s/he may initiate (via the input device 204) the search mode of the RFID reader 200 at location waypoint 110. As soon as the user puts the RFID reader 200 into operation by pressing a trigger, a key on the keyboard, or on-screen button, or autonomously such as by detecting RFID reader motion, the RFID reader 200 transmits a signal to interrogate the RFID tag 202 associated with the item 106 and receives a responsive signal returned from the RFID tag 202. The processor determines receive quality data from one or more receive quality indicators for the responsive signal and stores that (those) values in the memory 308.

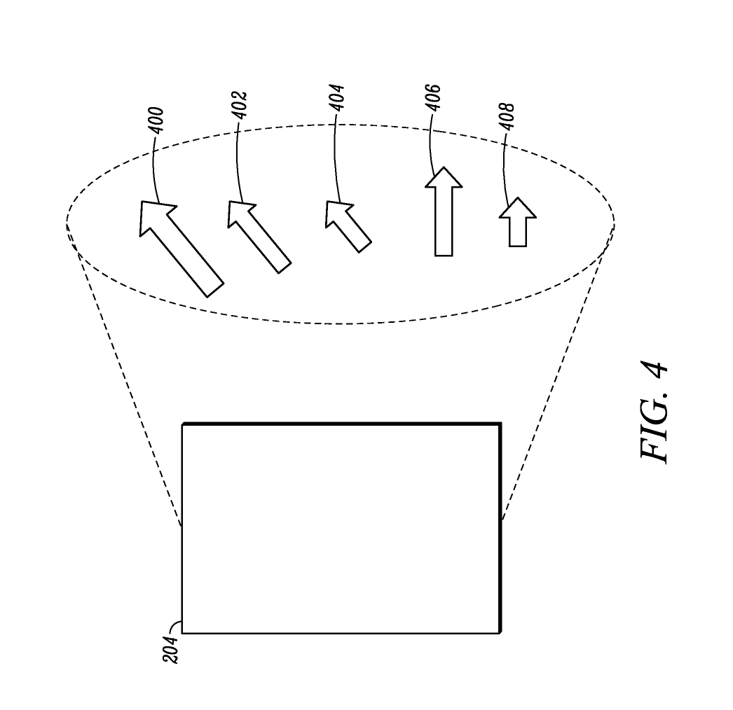

As the user moves along the path 108 toward location (waypoint) 112, the RFID reader continues to communicate with the RFID tag 202 and the processor compares the receive quality indicators to those of previously received responsive signals to determine (or estimate) whether the user is moving toward, away or parallel to the RFID tag (and thus the item 106). The user is provided an indication of a direction between the RFID reader 200 (where the user is now) toward the RFID tag 202 via one or more of the annunciators 312. In one embodiment, this indication of direction is provided as illustrated in FIG. 4. Thus, at location waypoint 110 the receive quality indicators of the responsive signal may be poor and determined to be along a path indicated by a (compass) arrow display 400. In some embodiments, the length of the displayed arrow 400 is inversely proportional to the receive quality indicators of the responsive signals, so that the displayed arrow 400 appears longer when the RFID tag 202 is a far distance from the RFID reader 200.

As the user reaches location (waypoint) 112, the displayed direction may be as shown by arrow 402 since the user has moved somewhat closer to the item 106 (and its RFID tag). By location waypoint 114, the displayed direction indicator may be as shown by arrow 404 (still decreasing in size as the item is approached), however, the user is impeded from following the direction indicated by the arrow 404 due to the shelving 102 (see FIG. 1). Still following path 108, the user passes the shelving 102 and by location waypoint 116, the display 206 is presenting arrow 406 to indicate the direction between the RFID reader and the RFID tag 202. Finally, as the user arrives at the display table 104′ (at location waypoint 118), the item 106 is located and the display 206 may be presenting arrow 408 indicating the item 106 is directly ahead and very close as the size of the arrow 408 is quite small. Additionally, at this point, the arrow 408 may optionally flash or change color to indicate that the item 106 is very near.

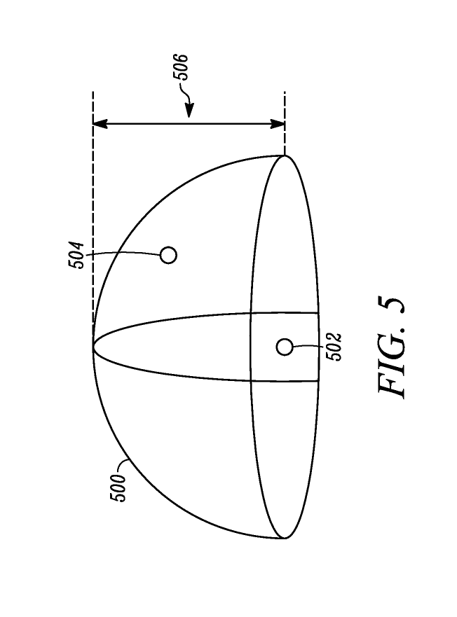

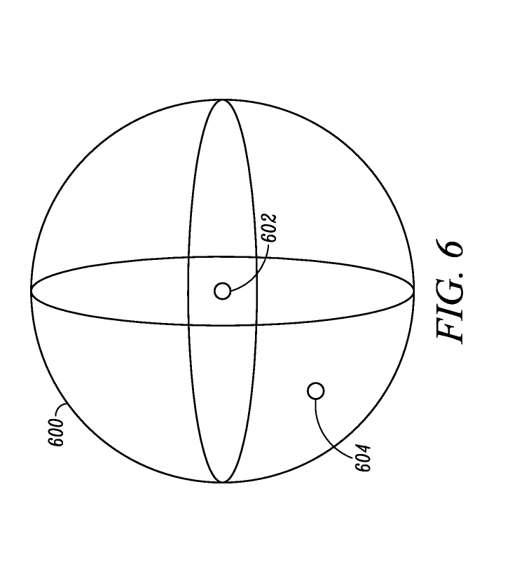

FIGS. 5-6 are illustrations of other exemplary screen displays for the RFID reader 200 during a search for an item. In FIG. 5, a two-dimensional representation of a hemisphere 500 may be displayed on the display 206 (see FIG. 2). A centrally located icon 502 represents the RFID reader 200 (and thus, the user's present location), while another icon 504 indicates the determined direction between the RFID reader 200 and the RFID tag 202. This embodiment is particularly useful for item storage areas have tall (high) shelves such as backroom storage in a retail store or a warehouse storage facility. The hemisphere 500 provides altitude information to the user in addition to the general two-dimensional direction toward the RFID tag 202. It may be particularly useful if the displayed height 506 of the hemisphere 500 corresponded to (or was calibrated to) the ceiling height of the item storage area. In this way, a scaled representation of the height of the item above the floor or below the ceiling may assist in locating the item being searched.

FIG. 6 expands upon the display concept of FIG. 5 and presents to the user a two-dimensional representation of a sphere 600. This display indication of direction between an RFID reader 200 and a searched for RFID tag 202 is particularly useful in multi-level storage areas that may includes elevated platforms or walkways along very tall shelving. In the example illustrated in FIG. 6, the user may understand that the item to be located 604 is below him/her on the left, and slightly behind his/her current position as indicated by icon 602.

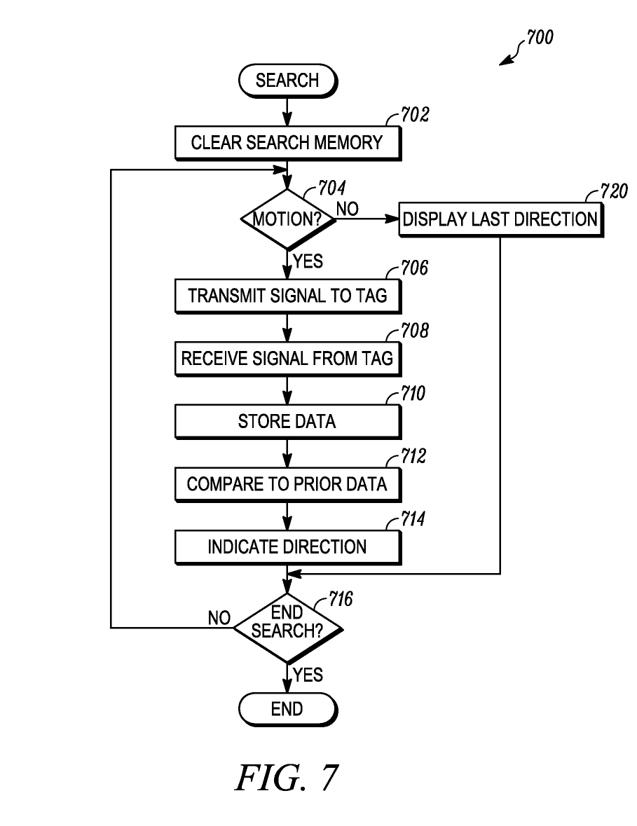

FIG. 7 is a flowchart of a method 700 for locating items having an RFID tag 202 (see FIG. 2) in accordance with some embodiments. As noted earlier, the method 700 is initiated by a user operating the input device (204 in FIG. 2) or the trigger of the RFID reader 200 to enter the search mode and to identify the RFID tag (202 in FIG. 2) that is the subject of the search. The routine begins in step 702 where the memory (308 in FIG. 3), or at least that portion of the memory for storing search data, is cleared to begin a new search. Decision 704 determines whether the RFID reader is in motion, and if so, a direction of travel. Motion can be determined via the motion detector (310 in FIG. 3) or the orientation sensors (318 in FIG. 3), and the direction of travel may be obtained via the orientation sensors or other direction indicator such as an electronic compass with the motion detector 310. Initially, the motion may be in any random direction as the user will be directed toward the RFID tag as soon as sufficient data is available. While in motion, the RFID reader transmits interrogation signals to the RFID tag (step 706) and receives responsive signals from the RFID tag (step 708). The responsive signals are processed (via processor 304 of FIG. 3) to derive receive quality data, which is stored in step 710. When sufficient data is stored and available for comparison, step 712 compares the most recent received quality data with historical (during the search) data to determine a direction between the RFID reader and the RFID tag. The determined (estimated) direction is presented to the user in step 714 (see also FIGS. 4-6). Decision 716 determines if the user has exited the search mode (ended the search), such as, for example, by locating the item. If not, the routine returns to decision 704 and the routine repeats to collect additional receive quality data and direct the user toward the RFID tag (and thus the item).

However, if the determination of decision 704 is that motion has ceased, the last indicated direction continues to be displayed (step 720) and the routine jumps to decision 716 to determine whether the user has ended the search. A negative determination of decision 716 could indicate that the user has paused momentarily along the search path (108 in FIG. 1); perhaps to look for the item. Conversely, an affirmative determination ends the method 700 at step 718.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as critical, required, or essential features or elements of any or all the claims. The invention is defined solely by the appended claims including any amendments made during the pendency of this application and all equivalents of those claims as issued.

Moreover in this document, relational terms, such as, first and second, top and bottom, and the like, may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a Read Only Memory (ROM), a Programmable Read Only Memory (PROM), an Erasable Programmable Read Only Memory (EPROM), an Electrically Erasable Programmable Read Only Memory (EEPROM) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method, comprising:
transmitting an interrogation signal for at least one radio frequency identification (RFID) tag to initiate a responsive signal from the at least one RFID tag;
receiving the responsive signal from the at least one RFID tag;
processing the responsive signal and data from one or more orientation sensors to determine a direction from the RFID reader toward the at least one RFID tag; and
displaying the direction toward the at least one RFID tag.

2. The method of claim 1, further comprising:
detecting movement of the RFID reader; and
repeating the method while movement is detected.

3. The method of claim 2, wherein detecting movement of the RFID reader further comprises receiving a signal from an accelerometer configured within the RFID reader.

4. The method of claim 2, wherein the one or more orientation sensors determine an orientation of the RFID reader while movement is detected.

5. The method of claim 4, wherein determining the orientation of the RFID reader further comprises detecting a change in a pitch, roll or yaw position of the RFID reader.

6. The method of claim 2, further comprising displaying a last determined direction when movement detection ceases.

7. The method of claim 1, wherein determining a direction from the RFID reader toward the RFID tag further comprises determining a direction from the RFID reader toward the RFID tag based at least in part upon a signal strength of the responsive signal as compared with signal strengths received at previous positions of the RFID reader.

8. The method of claim 1, wherein determining a direction from the RFID reader toward the RFID tag further comprises determining a direction from the RFID reader toward the RFID tag based at least in part upon a read rate of the RFID tag as compared with read rates received at other positions of the RFID reader.

9. The method of claim 1, further comprising receiving an identification number of an RFID tag to be located.

10. A radio frequency identification (RFID) tag reader, comprising:
a user input device for receiving an identification signal of an RFID tag to be located;
a motion detection unit for detecting motion of the RFID tag reader and providing a motion signal;
a transmitter for transmitting an interrogation signal to the RFID tag responsive to the motion signal;
a receiver for receiving a responsive signal from the RFID tag;
an orientation unit providing data representing the orientation of the RFID tag reader;
a processor coupled to the user input device, the motion detection unit, the transmitter, the receiver and the orientation unit for processing the responsive signal and the data representing the orientation of the RFID tag reader to determine a direction between the RFID tag reader and the RFID tag; and
a display for displaying the direction.

11. The RFID tag reader of claim 10, wherein the motion detection unit comprises an accelerometer.

12. The RFID tag reader of claim 10, wherein the motion detection unit comprises at least one motion sensor configured to detect at least one of the following: roll, pitch or yaw.

13. The RFID tag reader of claim 10, further comprising a received signal strength indicator and wherein the processor determines a direction from the RFID tag reader toward the RFID tag based at least in part upon a signal strength of the responsive signal as compared with signal strengths received at previous positions of the RFID reader.

14. The RFID tag reader of claim 10, wherein the processor determines a read rate of the responsive signal and determines a direction from the RFID reader toward the RFID tag based at least in part upon the read rate of the responsive signal as compared with read rates received at other positions of the RFID reader.

15. The RFID tag reader of claim 10, wherein the display presents a last determined direction responsive to cessation of the motion signal.

16. A method, comprising:
transmitting an interrogation signal for at least one RFID tag to initiate a responsive signal from the at least one RFID tag;
receiving the responsive signal from the at least one RFID tag;
processing the responsive signal to determine a direction from the RFID reader toward the at least one RFID tag by comparison of receive quality indicators of the responsive signal to previously received responsive signals; and
displaying the direction toward the at least one RFID tag.

17. The method of claim 16, further comprising detecting movement of the RFID reader.

18. The method of claim 17, wherein detecting movement of the RFID reader further comprises detecting a change in a pitch, roll or yaw position of the RFID reader.

19. The method of claim 18, further comprising displaying a last determined direction when movement detection of the RFID reader ceases.

20. The method of claim 16, further comprising receiving an identification number of an RFID tag to be located.
